(19) United States
(12) Patent Application Publication
(10) Pub. No.: US 2006/0091648 A1
(43) Pub. Date: May 4, 2006

(54) Vehicle interior paneling part having airbag cover

(75) Inventor: Willi Wissel, Blankenbach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/261,219

(22) Filed: Oct. 28, 2005

(30) Foreign Application Priority Data
Nov. 4, 2004 (DE) 20 2004 017 029.9

(51) Int. Cl. B60R 21/20

(52) U.S. Cl. 280/728.3

(57) ABSTRACT

A vehicle interior paneling part (10) has an integrated cover that can swing open and that is designed for a vehicle occupant restraint module. The paneling part (10) includes a support part (12). The support part (12) has a predefined breakaway line (16) that defines the contour of the cover. The paneling part (10) further includes a decorative layer (14) which is applied to the support part (12) and has a tear-off line (20). The tear-off line (20) in the decorative element (14) at least in sections meanders about the breakaway line (16) in the support part (12).

### TECHNICAL FIELD

The present invention relates to a vehicle interior paneling part.

### BACKGROUND OF THE INVENTION

From German Patent DE 196 36 428 B4, a vehicle interior paneling part is known, which is made up of a three-layer composite material. The paneling part comprises an integrated cover that can swing open and that is designed for a vehicle occupant restraint module. The paneling part includes a support part. The support part has a predefined breakway line that defines the contour of the cover. The paneling part further includes a decorative layer which is applied to the support part and has a tear-off line. To generate the breakaway line that defines the contour of the airbag cover, the composite material is punctured in the upper layer. The breakaway line meanders about an imaginary straight line, so as to produce a very deep breakaway line that is yet not visible to the occupants.

Published German Patent Application DE 199 10 141 A1 indicates a cover for an airbag unit, which is made up of a support layer and a decorative layer, for example. Subsequently, tear-off lines are cut into the cover without penetrating through the cover. The tear-off lines can be wave-shaped in order to improve break-through resistance when the cover is stressed from the outside.

Generating a breakaway line in a composite material, one that extends into the upper, decorative layer, is relatively expensive and, due to the separation of the support part, does not permit any breakaway line to pass entirely through the material. If, according to another manufacturing process, a breakaway line is provided in the support part, and a decorative layer (e.g., serrated leather) provided with a tear-off line that corresponds to the breakaway line is subsequently laminated onto the support part, it then proves difficult to position the cut in the decorative layer exactly over the breakaway line in the support part. This positioning is made even more difficult by changes that occur in the dimensions of the materials during preparation and processing and that are caused by the influence of stress, temperature, and humidity.

The present invention provides a vehicle interior paneling part of the type cited above, in which the tear-off line in the decorative layer can be generated in a cost-effective manner, and the subsequent positioning of the decorative layer on the support part having the predefined breakaway line is simplified.

### BRIEF SUMMARY OF THE INVENTION

The vehicle interior paneling part according to the invention comprises an integrated cover that can swing open and that is designed for a vehicle occupant restraint module. The paneling part includes a support part. The support part has a predefined breakaway line that defines the contour of the cover. The paneling part further includes a decorative layer which is applied to the support part and has a tear-off line. The tear-off line in the decorative element at least in sections meanders about the breakaway line in the support part. The tear-off line preferably corresponds to a sine curve. Accordingly, no attempt is made to achieve congruence between the tear-off line and the breakaway line, which is “straight” in comparison thereto. Rather, it is sufficient when the decorative layer is positioned on the support part such that the predefined breakaway line in the support part lies within the amplitude of the sine curve of the tear-off line. In this way, the permissible tolerance in positioning the decorative layer on the support part is increased. The tear-off line can be produced using known methods such as laser or oscillating-blade cutting. In comparison to sharp-edge cutting processes producing small cut surfaces, in the case of a sinusoid tear-off line, the processing time for manufacturing is reduced, so that manufacturing costs can be held down. The sinusoidal tear-off line also assures a smooth tearing off of the decorative layer without force discontinuities, and the risk of an uncontrolled rupture and the separation of particles is reduced. The tear-off process can be influenced in a controlled manner through the selection of the amplitude and the wavelength of the sine curve.

To create starting locations, at which the tear-off process is compelled to begin, it is recommendable to shorten the wavelength of the sine curve especially in the areas in which the greatest forces are exerted when the airbag is deployed from the restraint module. In this manner, the tear-off line and the breakaway line repeatedly intersect each other at short intervals, so that at these locations the weakening of the material of the vehicle interior paneling part is increased as a whole.

In order to assure that the tear-off line remain substantially invisible, it is advantageous to form the tear-off line so that it is not continuous. Ideally, the tear-off line is interrupted at the vertecies of the sine curve.

In the event of a branching of the tear-off line, it has proven to be advantageous if the branch point corresponds to a vertex of the sine curve. In this way, even in branching area, it is possible to achieve a uniform, controlled tear-off process.

### BRIEF DESCRIPTION OF THE DRAWINGS

FIG. 1 depicts a top view of a part of a vehicle interior paneling part according to the present invention; and

FIG. 2 depicts an enlarged sectional view of area A of FIG. 1.

### DETAILED DESCRIPTION OF THE PREFERRED EMBODIMENT

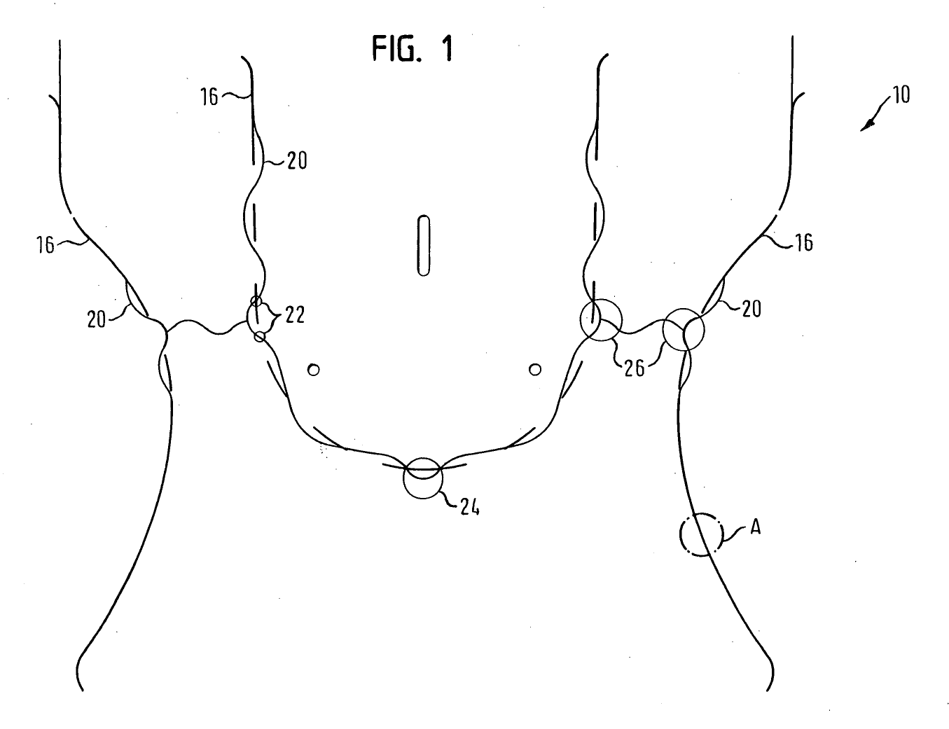

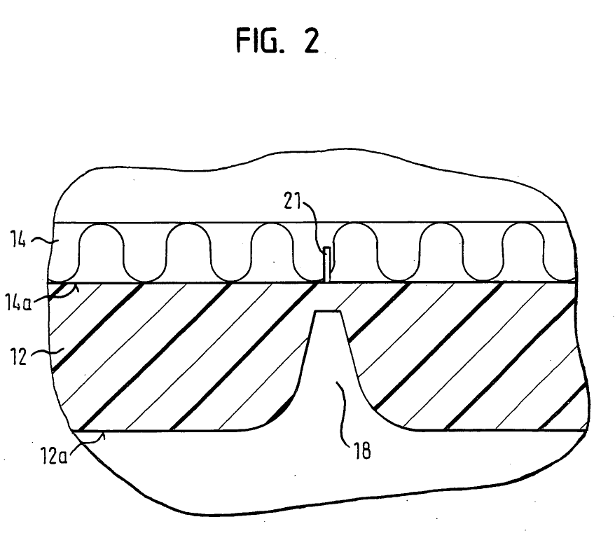

The vehicle interior paneling part 10 depicted in FIG. 1 is a part of a vehicle steering wheel and covers an airbag module that is accommodated therein. Paneling part 10, as can be seen in FIG. 2, is made up of a plastic support part 12 and a decorative layer 14, which is laminated onto support part 12. Decorative layer 14 can be leather, imitation leather, woven fabric, knitted fabric, a microfiber system, foil, plywood, or the like.

In support part 14, a breakaway line 16 is provided, which defines an airbag module cover that can swing open. Breakaway line 16 is formed by a weakening 18 in the material of support part 12. Weakened material 18 can be produced as early as during the injection-molding or foam-molding of support part 12 or later through the removal of material. Weakened material 18 in cross section has the shape of a tapering groove. The groove extends from side 12a, which faces away from decorative layer 14, into support part 12 without completely penetrating the latter, however.

Decorative layer 14 has a tear-off line 20, which in the case of leather can be produced, e.g., by an incision 22 (depicted in FIG. 2 in expanded form). Tear-off line 20 extends in cross section, as depicted in FIG. 2, from side 14a, which faces support part 12, into decorative layer 14 to a depth that represents roughly 50 to 70% of the thickness of decorative layer 14.

As can be discerned from FIG. 1, although tear-off line 20 fundamentally corresponds to breakaway line 16 -in support part 12, the lines are not congruent. Rather, tear-off line 20 in some segments meanders in the shape of a sine curve about breakaway line 16 in support part 12. In the other sections, the tear-off line has the same straightness as breakaway line 16.

In certain areas, the wavelength of the sine curve of tear-off line 20 is significantly shortened, the amplitude being kept virtually the same, so that in these areas tear-off line 20 in decorative layer 14 intersects breakaway line 16 in support part 12 more frequently. In the areas designated as 22, 24, 26, in each case two intersection points are situated right behind each other, whereas in the other areas, having a relatively flat wave profile, two successive intersection points are a significantly greater distance from each other. Areas 22, 24, 26 having a shortened wavelength constitute starting locations, at which the weakening of the interior paneling part is overall the greatest. These places are situated over the areas in which the greatest forces are exerted when the airbag is deployed from the restraint module, so that an initial opening of the cover is achieved as rapidly as possible.

Tear-off line 20 is interrupted at several locations, in order to counteract its perception on the visible surface of decorative layer 14. In the example depicted, the interruptions are situated at the vertecies of the sine curve. The length of the interruptions at which the tear-off line in decorative layer 14 has the full thickness, can amount to, e.g., 80% of this thickness.

In FIG. 1, areas 26 are shown in which tear-off line 20 branches. The branch points are selected so that they coincide with vertecies of the sine curve.

1. A vehicle interior paneling part, comprising an integrated cover that can swing open and that is designed for a vehicle occupant restraint module, the paneling part including a support part, the support part having a predefined breakaway line that defines the contour of the cover, the paneling part further including a decorative layer, which is applied to the support part and has a tear-off line, wherein the tear-off line in the decorative element at least in sections meanders about the breakaway line in the support part.

2. The vehicle interior paneling part as recited in claim 1, wherein the tear-off line corresponds to a sine curve.

3. The vehicle interior paneling part as recited in claim 2, wherein in specific areas the wavelength of the sine curve is shortened.

4. The vehicle interior paneling part as recited in claim 2, wherein the tear-off line is interrupted at the vertecies of the sine curve.

5. The vehicle interior paneling part as recited in claim 2, wherein the tear-off line branches at a branch point, the branch point corresponding to a vertex of the sine curve.
